(19) United States
(12) Patent Application Publication
(10) Pub. No.: US 2021/0019849 A1
(43) Pub. Date: Jan. 21, 2021

(54) Method for External Data-Based Constructing Various Triggering Mechanisms to Execute Smart Contract in Blockchain Network and System Thereof

(71) Applicant: SHANGHAI FENFU INFORMATION TECHNOLOGY CO., LTD., Shanghai (CN)

(72) Inventors: Dejun Qian, Shanghai (CN); Guochang Xu, Shanghai (CN); Bin Jiang, Shanghai (CN); Jiangang Wu, Shanghai (CN); Zhaojun He, Shanghai (CN); Xi Luo, Shanghai (CN)

(73) Assignee: SHANGHAI FENFU INFORMATION TECHNOLOGY CO., LTD., Shanghai (CN)

(21) Appl. No.: 17/043,800

(22) PCT Filed: Jul. 19, 2018
(86) PCT No.: PCT/CN2018/096213

§ 371 Date: Sep. 30, 2020

(30) Foreign Application Priority Data
Mar. 30, 2018 (CN) 201810296430.0

(51) Int. Cl. G06Q 50/18; G06F 9/54

(52) U.S. Cl. CPC G06Q 50/18; G06F 9/547

(57) ABSTRACT

The present invention relates to a method for external data-based constructing various triggering mechanisms to execute smart contract in blockchain and system thereof, the method comprises: first, issuing a smart contract on blockchain network and waiting for the confirmation of all participants of the smart contract; and then, the trigger component in the blockchain network calls external data according to the customized trigger mechanisms in the smart contract, and issues transaction broadcast information to network-wide distributed nodes when the external data is after polled as satisfying any of the trigger mechanisms; and finally, the network-wide distributed nodes respectively call and verify the external data corresponding to the triggered smart contract. The use of the method for external data-based constructing various triggering mechanisms to execute smart contract in blockchain and system thereof, implements the calling of the external data for the smart contract in the blockchain, and uses this as a basis for triggering the corresponding smart contract, ensures that independent and complete execution can be implemented once the smart contract is triggered, thus expanding for the smart contract to implementation of support for a complex application scenario.

### CROSS-REFERENCE TO RELATED APPLICATION

This application claims priority of Chinese Invention Patent Application No. 201810296430.0 filed Mar. 30, 2018, which is incorporated herein by reference.

### FIELD OF TECHNOLOGY

The present invention relates to the technical field of blockchain, in particular to the technical field of external trigger mechanisms, specifically, it refers to an external data-based method and system for constructing various triggering mechanisms for executing a smart contract in a blockchain.

### DESCRIPTION OF RELATED ARTS

The term smart contract was coined in 1995 by Nick Szabo, a prolific cross-field legal scholar. He defines the smart contract as: a set of promises defined in digital form, including agreements on which contract participants can execute these promises.

However, the definition of the above smart contract has not been fully implemented, the main reason is the lack of a basic environment in which the execution process is not interfered by the outside world and the results of the execution cannot be tampered with and can be effectively saved. This situation has been changed with the development of blockchain technology, the blockchain determines participants, consensus mechanism through cryptography, based on the distributed network, the data recording mode of blockchain and other technical means meet the above conditions.

However, most of the current smart contracts in the blockchain have the following problems:

1. only support a single trigger mode is not enough to meet the realization of more application scenarios:

the current trigger mechanism of smart contracts is triggered by a transaction that transfers money to the contract address. In actual applications, there are a large number of application scenarios that rely on time trigger or event trigger, and implementation of these applications under existing smart contracts is problematic.

For example if there is such a situation, from the time Alice and Bob sign the smart contract, if the Shanghai Stock Exchange Composite Index exceeds 3000 points within ten days, then the smart contract completes the payment of Alice to Bob, on the contrary, the smart contract saves the value in the contract and return it to Alice. If both Alice and Bob confirm this smart contract, that a promise is formed, use Alice to transfer the agreed payment value to the smart contract, and transfer it to the contract for storage and custody to start, then implement the functions of existing smart contracts, someone needs to initiate a trigger transaction to the smart contract during these ten days, when the Shanghai Stock Exchange Composite Index exceeds 3000 points, or when the Shanghai Stock Exchange Composite Index never meets the requirements and expires in ten days, and use this situation as a part of the trigger transaction input data, and input to the smart contract by trigger transaction, so that the smart contract can be activated and executed (see FIG. 1), we know, the smart contract is a promise that is realized use digital form in code, and is executed by a computer or network, then to ensure that the smart contract can complete the execution of the promise the following two conditions must be met:

Firstly, the execution of the smart contract will not be interrupted for any reason since the execution of the smart contract.

Secondly, the smart contracts will not produce results that violate preset conditions and actual conditions.

Both of these situations may exist in this process.

First of all, the smart contracts can only be activated by triggering transactions, which means that current smart contracts do not have to judge external conditions and self-activate ability. In the application scenario just now, it must rely on the 504th with the smart contract as the transaction of target address, and then to trigger the smart contract for subsequent execution.

This transaction needs to be initiated by an individual from the real world, if the individual conflicts with the original smart contract benefits, it may cause no one to activate the contract again, which will cause the smart contract to be interrupted, and this also means the promise embodied in the smart contract cannot be completely executed. The uncertain factors brought about by human links bring great risks to the complete and reliable execution of smart contracts.

Secondly, the external data is input to the smart contract in the form of data from the second transaction, and the smart contract has no path or no way to proofread the data at 505th place, just can only calculate it. This means that the smart contract cannot judge whether the situation entered at the 504th place has actually happened, so that the execution of the smart contract according to the malicious error data will produce an error result that is contrary to the actual situation.

2. Does not support the ability to obtain and respond to system external data:

the reason that restricts the existing smart contracts from being unable to access external data, such as the agreed time conditions mentioned in point 1 above, and the event conditions of the Shanghai Stock Exchange Composite Index is that, the current smart contract mechanism only designs the acquisition of the data in the system, and does not design the way to obtain the external data of the system, so the corresponding capabilities cannot be established.

### SUMMARY OF THE INVENTION

The object of the present invention is to overcome the drawbacks of the prior arts, to provide a method for external data-based constructing various triggering mechanisms to execute smart contract in blockchain network and system thereof can to trigger smart contracts through external data.

In order to achieve the above objects, the present invention of method for external data-based constructing various triggering mechanisms to execute smart contract in blockchain network and system thereof has the following composition:

The method for external data-based constructing various triggering mechanisms to execute smart contract in blockchain network, characterized in that, the said method comprises:

(1) issuing a smart contract on blockchain network and waiting for the confirmation of all participants of the smart contract, and then the smart contract will be in a triggered state, waiting for to be loaded and executed when the trigger mechanism is satisfied;

(2) the trigger component in the blockchain network calls external data according to the customized trigger mechanisms in the smart contract, and issues transaction broadcast information to network-wide distributed nodes when the external data is after polled as satisfying any of the trigger mechanisms, in order to trigger the loading and execution of the smart contract by the network-wide distributed nodes;

(3) the network-wide distributed nodes respectively call and verify the external data corresponding to the triggered smart contract, ensure the authenticity of external data and the effectiveness of triggering the smart contract through the consensus validation mechanisms of network-wide distributed nodes, and complete the loading and execution of the triggered smart contract after the trigger mechanism passes the consensus validation mechanism.

In step (2) of the method for external data-based constructing various triggering mechanisms to execute smart contract in blockchain network, the trigger component in the blockchain network calling external data according to the customized trigger mechanisms in the smart contract, is specifically:

the trigger component calls the external data based on the connection relationship between the network-wide distributed nodes and API interface of the external data source through the network application protocol, and according to the customized trigger mechanism in the smart contract.

In step (2) of the method for external data-based constructing various triggering mechanisms to execute smart contract in blockchain network, the triggering the loading and execution of the smart contract by the network-wide distributed nodes, is specifically:

the satisfaction relationship between the external data and the customized trigger mechanism of the smart contract is established through one of the network-wide distributed nodes, and the transaction broadcast information is issued to the network-wide distributed nodes, in order to complete the network-wide distributed nodes triggers the smart contract. In step (3) of the method for external data-based constructing various triggering mechanisms to execute smart contract in blockchain network comprises the following steps:

(3.1) a one node of the network-wide distributed nodes executes the triggered smart contract, and simultaneously in the network-wide distributed nodes other nodes also execute the triggered smart contract according to the transaction broadcast information, and when executing the triggered smart contract, each node respectively calls the external data corresponding to the triggered smart contract, and verifies the preset response conditions of the external data;

(3.2) through the consensus validation mechanism a judgment is formed between the network-wide distributed nodes to determine whether the triggered smart contract meets the trigger mechanism or not, if not, returning to the step (2), otherwise, completing the execution of the triggered smart contract, and the execution result is recorded in the distributed ledger of the blockchain network, thus ending the whole process;

in step (2) of the method for external data-based constructing various triggering mechanisms to execute smart contract in blockchain network, the trigger component stores the trigger mechanism of each smart contract in the blockchain network.

The trigger mechanism of the method for external data-based constructing various triggering mechanisms to execute smart contract in blockchain network comprises a time trigger mechanism and an event trigger mechanism based on external data of the blockchain network.

The network application protocol of the method for external data-based constructing various triggering mechanisms to execute smart contract in blockchain network is http protocol or socks protocol.

The system for external data-based constructing various triggering mechanisms to execute smart contract in blockchain network, characterized in that, the system comprises:

an external data call module, is connected with the API interface of external data source through network application protocol to call external data;

a trigger component module, is connected with the external data call module, call external data according to the customized trigger mechanism in the smart contract, and after polling that the external data satisfies any one of the trigger mechanisms, the transaction broadcast information is issued to the network-wide distributed nodes, to trigger the loading and execution of the smart contract by the network-wide distributed nodes;

an external data validation module, used to verify the external data corresponding to the triggered smart contract, and through the consensus validation mechanism of network-wide distributed nodes to ensure the authenticity of external data and the effectiveness of triggering the smart contract.

The trigger component module of the system for external data-based constructing various triggering mechanisms to execute smart contract in blockchain network stores the trigger mechanism of each smart contract in the blockchain network.

The trigger mechanism of the system for external data-based constructing various triggering mechanisms to execute smart contract in blockchain network comprises a time trigger mechanism and an event trigger mechanism constructed based on external data of the blockchain system.

Using the method for external data-based constructing various triggering mechanisms to execute smart contract in blockchain and system thereof in this invention, first, the ability to connect and obtain external data from the blockchain is added, and then through the built trigger component (Calling list) to realize the detection and comparison mechanism for related conditions, able to implement the smart contracts on the blockchain to call external data, and use this as the trigger basis for the corresponding smart contracts, ensures that independent and complete execution can be implemented once the smart contract is triggered, once again through the method for external data-based constructing various triggering mechanisms to execute smart contract in blockchain network, it can execute each smart contract in the blockchain network completely, independently and reliably, thus expanding for the smart contract to implementation of support for a complex application scenario.

### BRIEF DESCRIPTION OF THE DRAWINGS

FIG. 1 shows a method of trigger smart contract in blockchain network of prior arts.

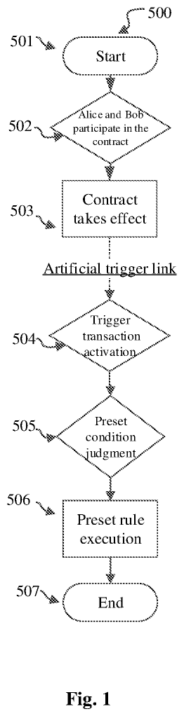

FIG. 2 is a process diagram of the method for external data-based constructing various triggering mechanisms to execute smart contract in blockchain of the present invention.

### DETAILED DESCRIPTION OF THE PREFERRED EMBODIMENT

In order to be able to understand the technical content of the present invention more clearly, is further exemplified by the following detailed description of embodiments.

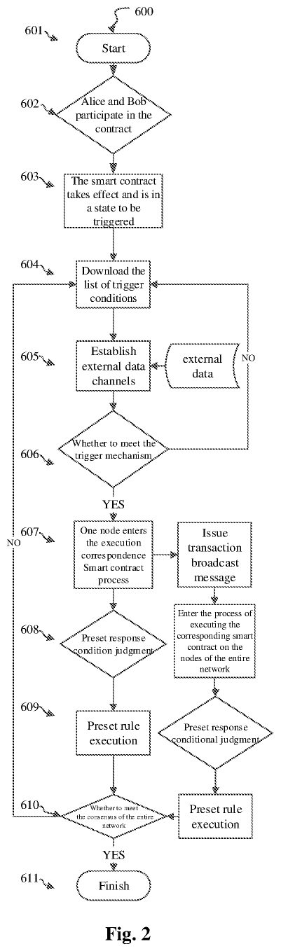

Please refer to FIG. 2, which is a process diagram of the method for external data-based constructing various triggering mechanisms to execute smart contract in blockchain of the present invention.

The method for external data-based constructing various triggering mechanisms to execute smart contract in blockchain, characterized in that, the method comprises:

(1) issuing a smart contract on blockchain network and waiting for the confirmation of all participants of the smart contract, and then the smart contract will be in a triggered state, waiting for to be loaded and executed when the trigger mechanism is satisfied;

(2) the trigger component in the blockchain network calls external data according to the customized trigger mechanisms in the smart contract, and issues transaction broadcast information to network-wide distributed nodes when the external data is after polled as satisfying any of the trigger mechanisms, in order to trigger the loading and execution of the smart contract by the network-wide distributed nodes;

(3) the network-wide distributed nodes respectively call and verify the external data corresponding to the triggered smart contract, ensure the authenticity of external data and the effectiveness of triggering the smart contract through the consensus validation mechanisms of network-wide distributed nodes, and complete the loading and execution of the triggered smart contract after the trigger mechanism passes the consensus validation mechanism.

In step (2) of the method for external data-based constructing various triggering mechanisms to execute smart contract in blockchain network, the trigger component in the blockchain network calling external data according to the customized trigger mechanisms in the smart contract, is specifically:

the trigger component calls the external data based on the connection relationship between the network-wide distributed nodes and API interface of the external data source through the network application protocol, and according to the customized trigger mechanism in the smart contract.

In step (2) of the method for external data-based constructing various triggering mechanisms to execute smart contract in blockchain network, the triggering the loading and execution of the smart contract by the network-wide distributed nodes, is specifically:

The satisfaction relationship between the external data and the customized trigger mechanism of the smart contract is established through one of the network-wide distributed nodes, and the transaction broadcast information is issued to the network-wide distributed nodes, in order to complete the network-wide distributed nodes triggers the smart contract.

In step (3) of the method for external data-based constructing various triggering mechanisms to execute smart contract in blockchain network comprises the following steps:

(3.1) a one node of the network-wide distributed nodes executes the triggered smart contract, and simultaneously in the network-wide distributed nodes other nodes also execute the triggered smart contract according to the transaction broadcast information, and when executing the triggered smart contract, each node respectively calls the external data corresponding to the triggered smart contract, and verifies the preset response conditions of the external data;

(3.2) through the consensus validation mechanism a judgment is formed between the network-wide distributed nodes to determine whether the triggered smart contract meets the trigger mechanism or not, if not, returning to the step (2), otherwise, completing the execution of the triggered smart contract, and the execution result is recorded in the distributed ledger of the blockchain network, thus ending the whole process.

In step (2) of the method for external data-based constructing various triggering mechanisms to execute smart contract in blockchain network, the trigger component stores the trigger mechanism of each smart contract in the blockchain network.

The trigger mechanism of the method for external data-based constructing various triggering mechanisms to execute smart contract in blockchain network comprises a time trigger mechanism and an event trigger mechanism based on external data of the blockchain network.

The network application protocol of the method for external data-based constructing various triggering mechanisms to execute smart contract in blockchain network is http protocol or socks protocol.

The present invention also relates to a system for external data-based constructing various triggering mechanisms to execute smart contract in blockchain network, characterized in that, the system comprises:

an external data call module, is connected with the API interface of external data source through network application protocol to call external data;

a trigger component module, is connected with the external data call module, call external data according to the customized trigger mechanism in the smart contract, and after polling that the external data satisfies any one of the trigger mechanisms, the transaction broadcast information is issued to the network-wide distributed nodes, to trigger the loading and execution of the smart contract by the network-wide distributed nodes;

an external data validation module, used to verify the external data corresponding to the triggered smart contract, and through the consensus validation mechanism of network-wide distributed nodes to ensure the authenticity of external data and the effectiveness of triggering the smart contract.

The trigger component module of the system for external data-based constructing various triggering mechanisms to execute smart contract in blockchain network stores the trigger mechanism of each smart contract in the blockchain network.

The trigger mechanism of the system for external data-based constructing various triggering mechanisms to execute smart contract in blockchain network comprises a time trigger mechanism and an event trigger mechanism constructed based on external data of the blockchain system.

In a specific embodiment, the method for external data-based constructing various triggering mechanisms to execute smart contract in blockchain network of the present invention has the ability to acquire external data of smart contracts, which are specifically:

(1) form an interface for input of external information of blockchain in the smart contract:

to obtain external data on the blockchain, use standard API interfaces provided by third-party data sources , by way of http or socks to implement blockchain computing node establish data connections with the data sources, and obtain related data.

In the present invention, solving the problem of obtaining external data from the blockchain by the smart contract is to provide a method for establishing a data path. The way to provide target data is to choose the existing API interface of the third-party data source, to avoid the need for additional data docking. At the same time, because it is a method of establishing a data path, this patent does not limit the specific data source, the specific data source can be agreed by the smart contract participants and indicated in the smart contract, which will be introduced in the smart contract components section below. At the same time, this way is also conducive to encapsulating the data calls of some commonly used out-of-chain data sources, in blockchain system, a way similar to system calls is implemented for supply or other computing nodes obtain data to use, has better adaptability and scalability;

(2) ensure the authenticity of the data:

the authenticity of obtained the out-of-chain data is based on the consensus mechanism. When a computing node finds that a certain smart trigger condition is met by the out-of-chain data, it forms a transaction broadcast and waits for execution. Even if this is a malicious node, deliberately telling the network-wide that a certain smart contract meets the trigger condition, it only means that other nodes will execute the smart contract, the first step of execution is to check the preset response conditions in the contract. Regardless of whether it is a smart contract triggered by a time or a condition (event), the trigger condition is also required to be a prerequisite for judgment in the preset response conditions, it is easy for other honest nodes to find that the conditions are not met during the execution of the smart contract and terminate the execution. Such malicious behavior will not have any destructive effect on the actual operation of the smart contract, and there will be no possibility of doing evil for profit.

In a specific embodiment, the method for external data-based constructing various triggering mechanisms to execute smart contract in blockchain network of the present invention has a smart contract with multiple trigger conditions that respond to external data, which is implemented through the following process:

(1) the writer of smart contracts:

the smart contract of the present invention expands the existing smart contract, and is compatible with the existing smart contract, the created smart contract includes two parts: contract definition and description, the definition part is consistent and compatible with existing Ethereum smart contracts. It contains the contract status, contract value, and preset response conditions and function code for response rules. Therefore, it is compatible with existing Ethereum and smart contracts on most blockchains.

The description part contains the trigger description to be used for this smart contract: select timing or event trigger mode, polling time, specified information source, etc.

(2) The issue of smart contract:

after the smart contract is issued, the storage of the definition part is consistent with the storage method of the existing smart contract on the blockchain. The description part will be merged with the trigger conditions of all smart contracts on the current blockchain to form a list of trigger condition (Calling list), it is also implemented by a smart contract. This list is stored in the block for the network-wide to access;

in the list, each row of records corresponds to a smart contract, in addition to what is contained in the description, each record also includes the index address corresponding to the smart contract store.

(3) The triggering of smart contracts in response to external data formation time and events:

(3-1) the computing node judges the trigger condition:

the list of trigger condition (Calling list) is downloaded from the node to the local for execution. The node polls the list, establishes a data channel with the API interface of the external data source of the blockchain through http or socks, obtains relevant data from the corresponding data source and judges whether the trigger condition is met;

(3-2) the trigger of smart contract:

in the polling at a certain moment, the computing node finds that the conditions of a certain smart contract are met, and then obtains the smart contract address according to the corresponding smart contract address index in the list of trigger conditions (Calling list) and triggers the smart contract, broadcast to the network-wide at the same time. Through the broadcast, computing nodes of the network-wide download the smart contract for execution.

In a specific embodiment, the method for external data-based constructing various triggering mechanisms to execute smart contract in blockchain network of the present invention execute the smart contract is specifically:

that is, it is executed in the node's operating environment (virtual machine). The trigger condition will also be the precondition of the smart contract preset judgment condition, each execution node independently obtains external data for verification, then through the consensus mechanism of the network-wide nodes, the wrong trigger is eliminated, and the smart contract is formed to respond accurately and effectively to external data.

Using the method for external data-based constructing various triggering mechanisms to execute smart contract in blockchain and system thereof in this invention, first, the ability to connect and obtain external data from the blockchain is added, and then through the built trigger component (Calling list) to realize the detection and comparison mechanism for related conditions, able to implement the smart contracts on the blockchain to call external data, and use this as the trigger basis for the corresponding smart contracts, ensures that independent and complete execution can be implemented once the smart contract is triggered, once again through the method for external data-based constructing various triggering mechanisms to execute smart contract in blockchain network, it can execute each smart contract in the blockchain network completely, independently and reliably, thus expanding for the smart contract to implementation of support for a complex application scenario.

In this specification, the present invention has been described with the reference to its specific embodiments. However, it is obvious still may be made without departing from the spirit and scope of the present invention, various modifications and transformation. Accordingly, the specification and drawings should be considered as illustrative rather than restrictive.

I claim:

1. A method for external data-based constructing various triggering mechanisms to execute smart contract in blockchain network, characterized in that, the said method comprises the following steps:
(1) issuing a smart contract on blockchain network and waiting for the confirmation of all participants of the smart contract, and then the smart contract will be in a triggered state, waiting for to be loaded and executed when the trigger mechanism is satisfied;
(2) the trigger component in the blockchain network calls external data according to the customized trigger mechanisms in the smart contract, and issues transaction broadcast information to network-wide distributed nodes when the external data is after polled as satisfying any of the trigger mechanisms, in order to trigger the loading and execution of the smart contract by the network-wide distributed nodes;
(3) the network-wide distributed nodes respectively call and verify the external data corresponding to the triggered smart contract, ensure the authenticity of external data and the effectiveness of triggering the smart contract through the consensus validation mechanisms of network-wide distributed nodes, and complete the loading and execution of the triggered smart contract after the trigger mechanism passes the consensus validation mechanism.

2. The method for external data-based constructing various triggering mechanisms to execute smart contract in blockchain network according to claim 1, characterized in that, in the step (2), the trigger component in the blockchain network calling external data according to the customized trigger mechanisms in the smart contract, is specifically:
the trigger component calls the external data based on the connection relationship between the network-wide distributed nodes and API interface of the external data source through the network application protocol, and according to the customized trigger mechanism in the smart contract.

3. The method for external data-based constructing various triggering mechanisms for executing a smart contract in blockchain network according to claim 2, characterized in that, in the step (2), the triggering the loading and execution of the smart contract by the network-wide distributed nodes, is specifically:
the satisfaction relationship between the external data and the customized trigger mechanism of the smart contract is established through one of the network-wide distributed nodes, and the transaction broadcast information is issued to the network-wide distributed nodes, in order to Method for External Data-Based Constructing Various Triggering Mechanisms to Execute Smart Contract Page 12 of 17 complete the network-wide distributed nodes triggers the smart contract.

4. The method for external data-based constructing various triggering mechanisms to execute smart contract in blockchain network according to claim 3, characterized in that, the said step (3) further comprises the following steps:
(3.1) a one node of the network-wide distributed nodes executes the triggered smart contract, and simultaneously in the network-wide distributed nodes other nodes also execute the triggered smart contract according to the transaction broadcast information, and when executing the triggered smart contract, each node respectively calls the external data corresponding to the triggered smart contract, and verifies the preset response conditions of the external data;
(3.2) through the consensus validation mechanism a judgment is formed between the network-wide distributed nodes to determine whether the triggered smart contract meets the trigger mechanism or not, if not, returning to the step (2), otherwise, completing the execution of the triggered smart contract, and the execution result is recorded in the distributed ledger of the blockchain network, thus ending the whole process.

5. The method for external data-based constructing various triggering mechanisms to execute smart contract in blockchain network according to claim 1, characterized in that, in the step (2), the trigger component stores the trigger mechanism of each smart contract in the blockchain network.

6. The method for external data-based constructing various triggering mechanisms to execute smart contract in blockchain network according to claim 5, characterized in that, the trigger mechanism comprises a time trigger mechanism and an event trigger mechanism based on external data of the blockchain network.

7. The method for external data-based constructing various triggering mechanisms to execute smart contract in blockchain network according to claim 2, characterized in that, the network application protocol is http protocol or socks protocol.

8. A system for external data-based constructing various triggering mechanisms to execute smart contract in blockchain network, characterized in that, the system comprises:
an external data call module, is connected with the API interface of external data source through network application protocol to call external data;
a trigger component module, is connected with the external data call module, call external data according to the customized trigger mechanism in the smart contract, and after polling that the external data satisfies any one of the trigger mechanisms, the transaction broadcast information is issued to the network-wide distributed nodes, to trigger the loading and execution of the smart contract by the network-wide distributed nodes;
an external data validation module, used to verify the external data corresponding to the Method for External Data-Based Constructing Various Triggering Mechanisms to Execute Smart Contract Page 13 of 17 triggered smart contract, and through the consensus validation mechanism of network-wide distributed nodes to ensure the authenticity of external data and the effectiveness of triggering the smart contract.

9. The system for external data-based constructing various triggering mechanisms to execute smart contract in blockchain network according to claim 8, characterized in that, the trigger component module stores the trigger mechanism of each smart contract in the blockchain network.

10. The system for external data-based constructing various triggering mechanisms to execute smart contract in blockchain network according to claim 9, characterized in that, the trigger mechanism comprises a time trigger mechanism and an event trigger mechanism constructed based on external data of the blockchain system. Method for External Data-Based Constructing Various Triggering Mechanisms to Execute Smart Contract Page 14 of 17
